(19) United States
(12) Patent Application Publication
(10) Pub. No.: US 2018/0370415 A1
(43) Pub. Date: Dec. 27, 2018

(54) MODULAR AWNING MOUNTS, MODULAR AWNING SYSTEMS AND RELATED METHODS FOR RECREATIONAL VEHICLES

(71) Applicant: Girard Guard. LLC, San Clemente, CA (US)

(72) Inventor: Johnnie Michael Mathiasen, San Clemente, CA (US)

(73) Assignee: Girard Guard. LLC, San Clemente, CA (US)

(21) Appl. No.: 16/016,259

(22) Filed: Jun. 22, 2018

Related U.S. Application Data
(60) Provisional application No. 62/524,402, filed on Jun. 23, 2017.

(51) Int. Cl. B60P 3/34; E04F 10/06

(52) U.S. Cl. CPC B60P 3/343; B62D 65/06; E04F 10/0666; E04F 10/0633

(57) ABSTRACT

Modular awning systems and related methods are disclosed. The modular awning system has a frame structure 3. The frame structure can be mounted to a roof of a vehicle. The modular awning system has an awning bracket for coupling to the frame structure, the awning bracket being for mounting an awning. The modular awning system has a front fairing and a rear fairing at opposed ends of the frame structure.

### FIELD OF THE ART

The present disclosure pertains to awning systems and related methods and more particularly to modular awning mounts and modular awning systems for recreational vehicles.

### BACKGROUND

A recreational vehicle (RV) can be of a pulled type that is pulled by a towing vehicle or it can be self-propelled with its own engine and drive train. Towed RVs can include a tent trailer, a trailer, and a fifth-wheel trailer. RVs with their own engine and drive train can range in size from small vans to Class A RVs built on heavy duty bus chassis.

Awnings are commonly found on RVs to provide a cover from sun and rain, when deployed at a rest location. A typical conventional awning can be automatically or manually deployed and retracted. Awnings can be positioned along one side or both sides of an RV such that when deployed, each awning can provide an exterior cover for enhanced user enjoyment, especially when the RV is also equipped with an exterior entertainment system.

### SUMMARY

Aspects of the present invention include a modular awning system for use with a vehicle, such as a recreational vehicle or any movable vehicle. The present invention further includes methods of using and making modular awning systems and components thereof. The modular awning system can be manufactured according to a first size for mounting to a wide range of vehicles and then sizable to a smaller second size to more appropriately fit a particular vehicle.

Components of the modular awning system that can be resized to fit a particular vehicle include a frame and one or more awnings. The frame can include multiple frame components that are manufactured to a respective first size and then sizable, such as trim down or cut down, to a shorter respective second size and then assembled to form a final modular awning system sized to fit a particular vehicle.

Thus, aspects of the present invention are understood to include a semi-custom fit modular awning system that is manufactured to a first size to cover a large range of vehicles and that can then be modified, such as trimmed, shortened, or cut, and then assembled from the modified pieces to an assembled size for a particular sized vehicle.

In some examples, the frame of the modular awning system is manufactured to a first size and is sizable to a smaller second side. However, the awnings can have a plurality of different first sizes with each awning sizeable to a smaller sub-set of second sizes. For example, a modular awning system in accordance with aspects of the present invention can include a single frame built to a first size and sizeable to a second size, such as by trimming or cutting one or more frame pieces. The same modular awning system can then have multiple awnings of different first lengths, with each awning customizable to a smaller sub-set of ranges. This allows the awning to be trimmed to cover a smaller size range, relatively speaking, than for the frame.

In other examples, there can be more than one frame with each frame configured to fit a smaller sub-set of vehicles. As a non-limiting example, a first frame can fit a vehicle of 46 feet to 52 feet vehicle length and second frame can fit a vehicle length of 48 feet to 42 feet, etc. The alternative modular awning system with multiple first frames for smaller sub-set of vehicles sizes can then have multiple awnings of different first lengths, with each awning customizable to a smaller sub-set of ranges. This allows the awning to be trimmed to cover a smaller size range, relatively speaking, than for the frame.

A frame can be mounted directly to a roof of a vehicle, such as to a recreational vehicle, the pulled typed or the self-propelled type, using fasteners and the like. The frame can include brackets for attaching to the vehicle. Brackets can also be used to secure one or more awnings to the frame. For example, a frame can have a first side aligned to a first side of a vehicle and a second side aligned to a second side of the vehicle. A first awning can be attached to the first side frame and optionally a second awning can be attached to the second side frame. The first and second side frames, or first and second elongated mains, can include brackets for use to secure one or two awnings.

First and second fairings may be incorporated to cover, or at least partially cover, the first and second ends of the frame, also first and second ends of each respective awning.

One or more embodiments of the present application can include a modular awning system comprising a first fairing, a second fairing, a frame disposed between the first fairing and the second fairing, and an awning coupled to the frame, wherein the awning and the frame are sizeable to necessary dimensions of a vehicle.

Embodiments can further include a bracket spacer and an awning bracket.

Additionally, embodiments can include wherein the awning is directly mounted to the awning bracket, wherein the awning bracket is directly mounted to the bracket spacer, and wherein the bracket spacer is directly mounted to the frame.

One or more embodiments of the present application can include a modular awning system for a vehicle comprising a front fairing configured to be mounted transversely across the vehicle, a first rear fairing and a second rear fairing, a frame disposed between the front fairing, the first rear fairing, the second rear fairing, and a first awning and a second awning, the first awning and the second awning coupled to the frame. Embodiments can include wherein the first awning, the second awning, and the frame are sizeable to necessary dimensions of the vehicle, wherein the front fairing is configured to cover respective first ends of the first awning and the second awning, and wherein each of the first rear fairing and the second rear fairing cover respectively cover an opposed second end of the first awning and the second awning.

One or more embodiments of the present application can include a modular awning system for a vehicle comprising a first fairing comprising a surface, two ends, and a center section located between the two ends, a second fairing spaced from the first fairing, a frame disposed between the first fairing and the second fairing, and an awning having cover fabric in a stowed-away state, said awning coupled to the frame.

Embodiments can include wherein the frame is sizeable from a first size to a second size, which is smaller than the first size, for use on a recreational vehicle.

The frame with the first size can fit a range of vehicles, including the noted recreational vehicle. However, when the frame is modified to the second size, the frame can fit a smaller range of vehicles than when the frame is in the first size. This allows the frame to be manufactured to a first size and then modifiable to a final size for a semi-custom fit to a particular vehicle.

Also, embodiments can include wherein the awning is sizeable from a first size to a second size, which is smaller than the first size, for use on a recreational vehicle.

Additionally, embodiments can further include a bracket spacer and an awning bracket secured to the awning.

In some embodiments, the awning is directly mounted to the awning bracket.

In some embodiments, the awning bracket is directly mounted to the bracket spacer.

In some embodiments, the bracket spacer is directly mounted to the frame.

Embodiments of the frame are made of at least one of metal, polymer, or composite. A particular metal frame can comprise extruded aluminum channels and extensions.

Also, embodiments can include wherein the awning comprises a motor operatively coupled to the cover fabric to extend or retract the cover fabric. The motor can be operated via a control switch or wirelessly using a remote control or a downloadable application software.

Some embodiments can include wherein the cover fabric is one of cloth or vinyl. The cover fabric is replaceable, such as for a different material, a different pattern, or when worn out.

Additionally, embodiments can include wherein the awning bracket comprises a first wall for mounting to the frame and a second wall, generally perpendicular to the first wall, for mounting the awning.

Also, embodiments can include wherein the awning is a first awning, and further include a second awning attached to the frame, spaced from the first awning. For example, the first awning can be mounted along a first side of the frame and the second awning can be mounted along a second side of the frame. The first and second sides of the frame can align with the first and second sides of a vehicle.

Embodiments can include wherein the frame comprise a first elongated main, a second elongated main, and a crossbar connected to the first elongated main and the second elongated main.

Some embodiments can include wherein the crossbar comprises a plurality of LEDs.

Also, embodiments can include wherein the crossbar is a first crossbar, and further include a second crossbar and a third crossbar. The three crossbars can be spaced from one another and each can connect to the first and second elongated mains.

Embodiments can include wherein the first crossbar, the second crossbar, and the third crossbar are generally parallel to one another. In other examples, fewer than three crossbars or greater than three crossbars can be incorporated.

Embodiments can include one or more solar panels mounted to the frame.

Embodiments can include a satellite or antenna mounted to the frame.

Embodiments can include wherein the frame is sized to fit around a roof mounted device, such as an air conditioning unit.

One or more embodiments of the present application include a modular awning system for a vehicle. The embodiments can include a first fairing configured to be mounted transversely at a front of a vehicle compared to a second fairing; said second fairing comprising a second fairing left part and a second fairing right part, a frame connected to the first fairing and the second fairing, said frame comprising a first elongated main, a second elongated main, and at least one crossbar connected to the first elongated main and the second elongated main, a first awning and a second awning, the first awning and the second awning coupled to the frame.

Embodiments can include wherein each of the first awning, the second awning, and the frame is sizeable from a first size to a second size, which is smaller than the first size, to scale the modular awning system to a vehicle.

Embodiments can include wherein the front fairing comprises a surface to cover respective first ends of the first awning and the second awning.

Embodiments can include wherein the second fairing comprises a surface to cover respective second ends of the first awning and the second awning.

A modular awning system for a vehicle in accordance with aspects of the present invention can comprise a first fairing configured to be mounted transversely at a front of a vehicle compared to a second fairing; said second fairing comprising a second fairing left part and a second fairing right part; a frame connected to the first fairing and the second fairing, said frame comprising a first elongated main, a second elongated main, and at least one crossbar connected to the first elongated main and the second elongated main; a first awning and a second awning, the first awning and the second awning coupled to the frame; wherein each of the first awning, the second awning, and the frame is sizeable from a first size to a second size, which is smaller than the first size, to scale the modular awning system to a vehicle; wherein the front fairing comprises a surface to cover respective first ends of the first awning and the second awning; and wherein the second fairing comprises a surface to cover respective second ends of the first awning and the second awning.

One or more embodiments of the present application include a method for mounting a modular awning system to a vehicle. The method can include shortening a frame from a first frame length to a second frame length to set the frame to the second frame length; the frame comprising a first end and a second end, shortening an awning from a first awning length to a second awning length to set the awning to the second awning length, attaching the awning to the frame and the frame to a roof of a vehicle, and placing a first fairing having a surface at the first end of the frame and a second fairing having a surface at the second end of the frame.

Also, embodiments of the method can include shortening a crossbar from a first crossbar length to a second crossbar length and attaching the crossbar to a first elongated main and a second elongated main.

Also, embodiments of the method can include wherein the crossbar is a first crossbar, further comprising shortening a second crossbar and attaching the shortened second crossbar to first elongated main and the second elongated main.

Additionally, embodiments of the method can further include wherein the awning is a first awning, and further comprising shortening a second awning and attaching the second awning to the frame.

Also, embodiments of the method can include wiring the frame to a power source to power LED lights mounted to the frame.

Embodiments of the method can further include using a remote control to extend a cover fabric from the awning.

### BRIEF DESCRIPTION OF THE DRAWINGS

These and other features and advantages of the present device, system, and method will become appreciated as the same becomes better understood with reference to the specification, claims and appended drawings wherein:

FIG. 1 shows an embodiment of a modular awning system in an assembled view.

FIG. 2 shows an exploded view of the embodiment of the modular awning system.

FIGS. 3A-3C show an embodiment of a first fairing.

FIGS. 4A-4D show an embodiment of a second fairing left part.

FIG. 5 shows an embodiment of an awning bracket.

FIG. 6 shows another embodiment of the awning bracket.

FIGS. 7A-7D show the dimensions of the embodiment of an awning bracket of FIG. 6.

FIG. 8 shows an embodiment of a modular awning system with awnings on both sides of the vehicle in an extended, or deployed, position as seen from a front-side view of the van.

FIG. 9 shows an embodiment of a modular awning system with an awning in an extended, or deployed, position as seen from a rear-side view of the van.

FIG. 10 shows an exemplary embodiment of a modular awning system with awnings on both sides of the vehicles in an extended, or deployed, position as seen from a rear-side view of the van.

FIG. 11 shows an embodiment of a modular awning system with awnings on both sides of the vehicles in an extended, or deployed, position as seen from a top-side view of the van.

FIG. 12 shows an embodiment of a modular awning system with awnings on both sides of the vehicles in an extended, or deployed, position as seen from an elevated perspective view of the van.

FIG. 13 shows an embodiment of a modular awning system with awnings on both sides of the vehicle in an extended, or deployed, position as seen from a front-side view of the van.

FIG. 14 shows an embodiment of a modular awning system with awnings on both sides of the vehicle in a fully retracted position as seen from a front-side view of the van.

FIG. 15 shows an embodiment of a modular awning system with awnings on both sides of the vehicle in an extended, or deployed, position as seen from a front-side view of the van.

FIG. 16 shows an embodiment of a modular awning system with awnings on both sides of the vehicle in a fully retracted position as seen from a front-side view of the van.

FIG. 17 shows an embodiment of a modular awning system with an awning in an extended, or deployed, position as seen from a rear-side view of the van.

FIG. 18 shows an embodiment of a modular awning system with an awning in a fully retracted as seen from a rear-side view of the van.

FIG. 19 shows an embodiment of a modular awning system with awnings on both sides of the vehicles in an extended, or deployed, position as seen from a rear-side view of the van.

FIG. 20 shows an embodiment of a modular awning system with awnings on both sides of the vehicle in a fully retracted position as seen from a rear view of the van.

FIG. 21 shows an embodiment of a modular awning system with awnings on both sides of the vehicles in an extended, or deployed, position as seen from a top-side view of the van.

FIG. 22 shows an embodiment of a modular awning system with awnings on both sides of the vehicles in a fully retracted position as seen from a top-side view of the van.

FIG. 23 shows an embodiment of a modular awning system with awnings on both sides of the vehicles in an extended, or deployed, position as seen from an elevated perspective view of the van.

### DETAILED DESCRIPTION

Aspects of the present disclosure can relate to modular awning mounts, modular awning systems, and related methods. A modular awning system can allow for improved quickness in sizing and installing an awning system. Embodiments may relate generally to vans, such as a [MERCEDES SPRINTER] or [FORD TRANSIT], and recreation vehicles (RV). Embodiments may also be applied to RVs of other dimensions, whether they are towed RVs or self-propelled RVs.

Exemplary embodiments use a representation of a van for illustrative purposes only. One of ordinary skill would readily recognize that the embodiments can be implemented on various types of vehicles, including for large class RVs. Additionally, one of ordinary skill would readily recognize that the embodiments can also be applied to temporary or fixed structures. Applications for embodiments can be found for structures for which shade may be desirable.

The description set forth in connection with the appended drawings is intended as a description of the presently preferred embodiments of modular awning systems provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Aspects of the present invention further include methods of using the modular awning systems and components thereof and of making the modular awning systems and components thereof as described herein.

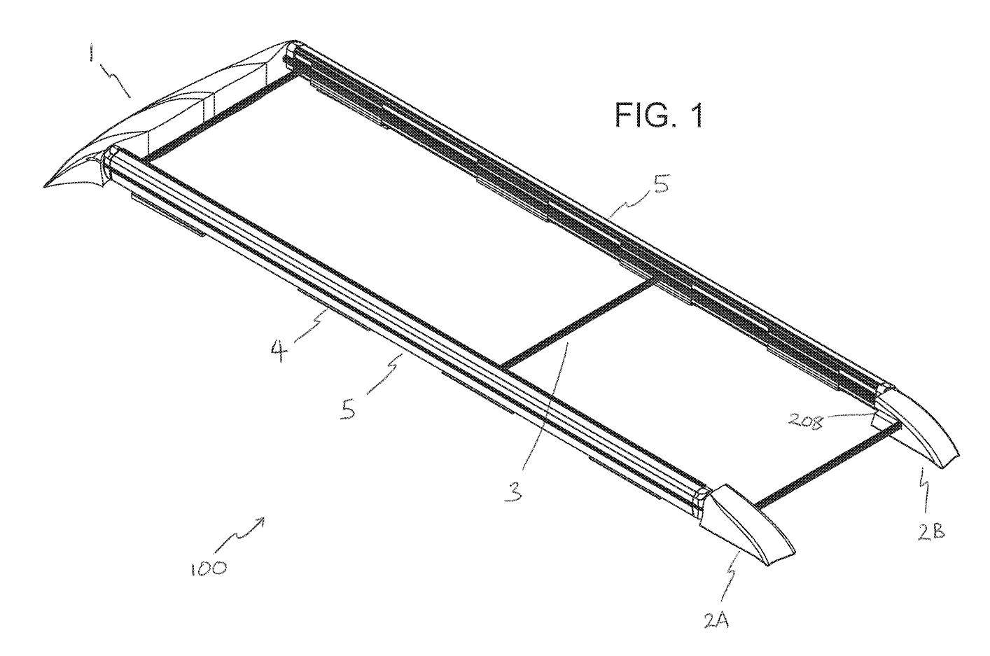

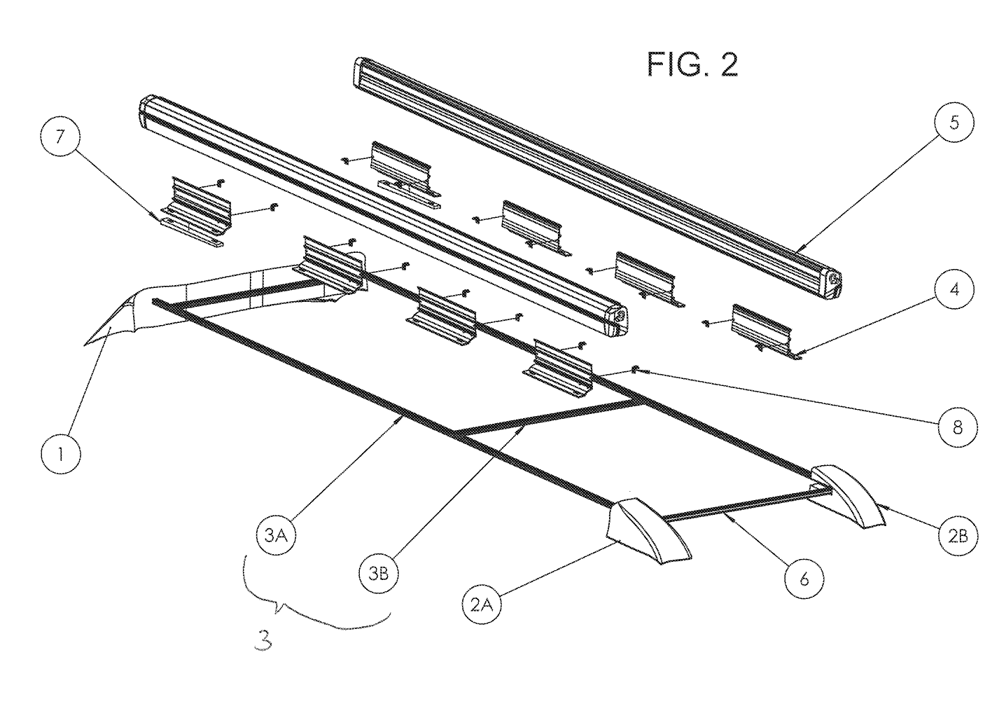

In FIG. 1, an embodiment of a modular awning system 100 is shown in an assembled perspective view. The orientation of the vehicle is used for illustrative purposes only, with the driver-forward-facing direction being considered a front end of a vehicle. The orientation of the modular awning system may be rotated as necessary. FIG. 1 shows an assembled modular awning system 100 with a frame structure 3, and left and right awnings 5 mounted to the frame structure 3 by way of a plurality of awning brackets 4. Additional detail is described in relation to FIG. 2 below. A first fairing 1 can be positioned at a first end of the awning system 100. The first fairing 1 can provide an aerodynamic shield for the awning system 100 and improve the aesthetics of the awning system 100. The awning system 100 can also have at least one second fairing at a second end of the awning system 100 opposite to the first end. In embodiment of FIG. 1, the second fairing has two parts with a second fairing left part 2A and a second fairing right part 2B. Alternatively, the second fairing can be a singular component across the frame structure 3 similar to the first fairing 1.

FIG. 2 illustrates an exploded view of the modular awning system. The first fairing 1 can be oriented towards a front end of a vehicle. In some embodiments, the first fairing can span across the width of the vehicle. The second fairing left part and right part 2A, 2B can be oriented towards a rear end of the vehicle. If a vehicle only has one awning installation, the frame can be sized accordingly and only one second fairing used. If a vehicle has two awning installations, it can be beneficial to have two separate second fairing parts. The usage of two separate second fairing left part and right part 2A, 2B may have application in aerodynamics or streamlining considerations. In some embodiments, the second fairing can be a component that spans across the width of the vehicle.

Between the first fairing 1 and the second fairing left part and right part 2A, 2B is a frame structure 3. The frame structure 3 can comprise of a structure that couples to the first fairing and the second fairing. In some embodiments, the frame structure 3 can have a box frame structure comprising main bars 3A and at least one crossbar 3B. A plurality of crossbars 3B can also be used. The main bars 3A can extend from the first fairing 1 to the second fairing left part and right part 2A, 2B. Embodiments of the frame structure 3 can be made from a suitable material, such as at least one of a metal, a polymer, a composite. In embodiments, the frame structure 3 can be made from a combination of materials, including composite reinforced metals, to provide sufficient strength. In embodiments, the frame structure 3 can be made from bars of different material. For example, the main bars 3A can be made from a steel, such as steel or aluminum, while the at least one crossbar 3B can be made from a polymer or a composite, such as carbon fiber. In some embodiments, the main bars may be made of T-slot extrusion, I-beam extrusion, or L-channel extrusion. The main bars 3A can be sized to fit necessary dimensions of the vehicle, such that the main bars 3A will fit between the first fairing 1 and the second fairing 2A, 2B. The frame structure may also have the crossbar 3B extend across from one of the main bars 3A to another of the main bars 3A. This can provide structural rigidity as necessary. In the exemplary embodiment, the crossbar can extend perpendicularly to the main bars 3A. However, alternative angles may be used, such as a diagonal brace. Combinations of perpendicular and diagonal crossbars may also be used in order to triangulate the frame structure. In addition to the crossbar, there can be a light emitting crossbar, which can include light sources attached to or recessed in the crossbar. The light emitting crossbar may be at a rear end of the frame and may house lights for either indication to other drivers or for illumination purposes. In some embodiments, the light emitting crossbar may comprise light emitting diodes (LED), fluorescent bulbs, or other light sources. In some embodiments, the light emitting crossbar can function as a brake light or turn signal indicators. In some embodiments, the light emitting crossbar can function as a tailgate light to provide illumination around the rear door area. Also, embodiments of the light emitting crossbar can allow for the displaying of illuminated text rearward. The illuminated text can be preprogrammed or programmable.

In some embodiments, there are provided bracket spacers 7 for mounting a plurality of awning brackets 4. The bracket spacers 7, the awning bracket 4, and the frame structure can be coupled through the use of components such as corner brackets 8 or fastening hardware. At least one of or both of the bracket spacers 7 and the plurality of awning brackets 4 can be manufactured in a variety of thicknesses and sizes to accommodate necessary design considerations for mounting of the modular awning system. For example, the awning mechanism may require height adjustment or the shape of a vehicle roof may necessitate a specific height for mounting the awning.

Awnings 5, which can include rollers, housings, mandrel or shaft, necessary motors and electronics, can be mounted to the awning brackets 4. The awning 5 can include a cover that is extendable and retractable, such as by rollers and motors. The cover of the awning can be called a cover fabric. The cover fabric can have a stowed away state or an extended state. The cover can be made of a flexible material, such as cloth, fabric, or vinyl. Alternatively, the awning 5 can be a rollable assembly of metal strips. Alternatively, the frame structure of the main bars 3A and crossbar 3B may be manufactured to allow for direct mounting of an awning 5. In such a case of a proprietary design, the modular awning system can be simplified by not requiring the bracket spacers and/or awning brackets.

In view of the arrangement of the frame structure 3 and the awnings 5, the modular awning assembly 100 can be easily sizeable relative to the length of a desired vehicle. The main bars 3A can be shortened as necessary for the length of a desired vehicle. Additionally, the awnings 5 can also be shortened as necessary for the length of the desired vehicle. In this way, a common supply of components for the frame structure 3 and the awnings 5 can be kept for usage across a variety of sizes of vehicles. The components for the frame structure 3 and the awning 5 can then be shortened as necessary for fitment to a particular vehicle.

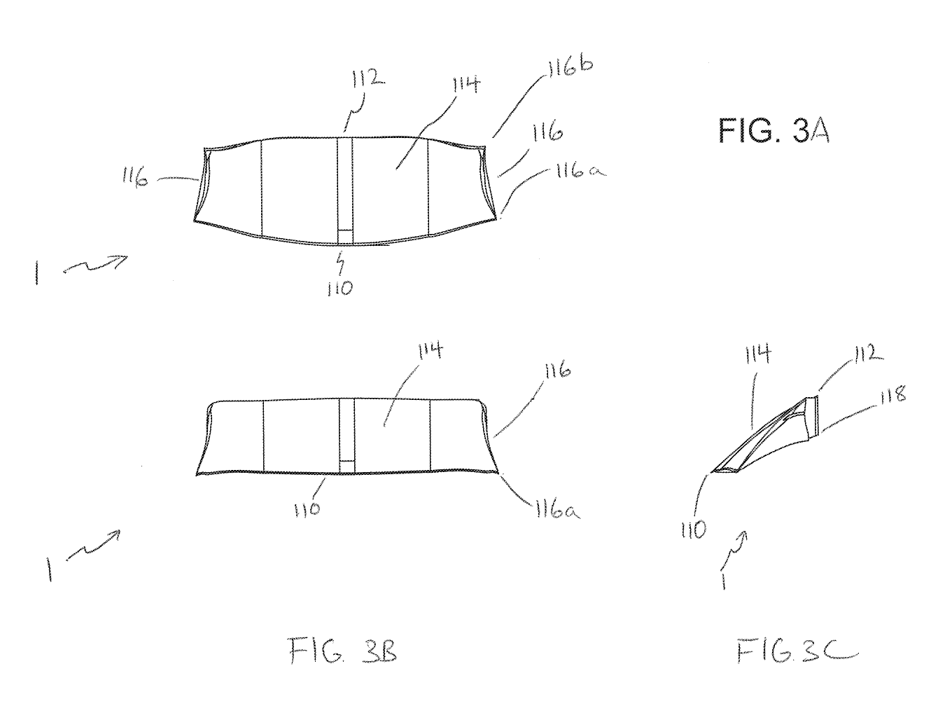

FIGS. 3A-3C illustrate an exemplary embodiment of the first fairing 1. The first fairing 1 may be shaped for various applications and desired look/feel. The first fairing 1, which can be oriented towards a front end of the vehicle, can be designed for aesthetic reasons and/or aerodynamic reasons. The first fairing 1 may shield the components of the awning system 100 from visibility by a person. The first fairing 1 may extend transversely across the vehicle at an angle. The first fairing may be a single piece or formed from multiple parts. As non-limiting examples, the exemplary first fairing can have dimensions of 59.84 inches in width and 14.78 inches in height. FIG. 3A illustrates a top plan view of the first fairing 1. The first fairing 1 can have a top plan view shape defined by a fairing surface 114 bounded by a forward edge 110, a rear edge 112, and a pair of side edges 116. In an installed positioned, the forward edge 110 of the first fairing to a forward corner 116a of the first fairing 1 may have a setback of 5.24 inches. The pair of side edges 116 can taper inwardly rearward from the forward corner 116a to the rear corner 116b. FIG. 3B illustrates a front plan view of the first fairing 1. The fairing surface 114 can have a front plan view height of 14.78 inches. The side edges 116 can taper inwardly upwards. FIG. 3C illustrates a side plan view of the first fairing 1. In an installed positioned, a forward lower edge 110 of the first fairing to a rear lower edge 118 of the first fairing 1 may have a drop of 7.38 inches. In other applications, the first fairing 1 may have different dimensions. The first fairing 1 can be made from a suitable material, such as at least one of a metal, a polymer, a composite. In embodiments, the first fairing 1 can be made from a combination of materials, including composite reinforced metals, to provide sufficient strength.

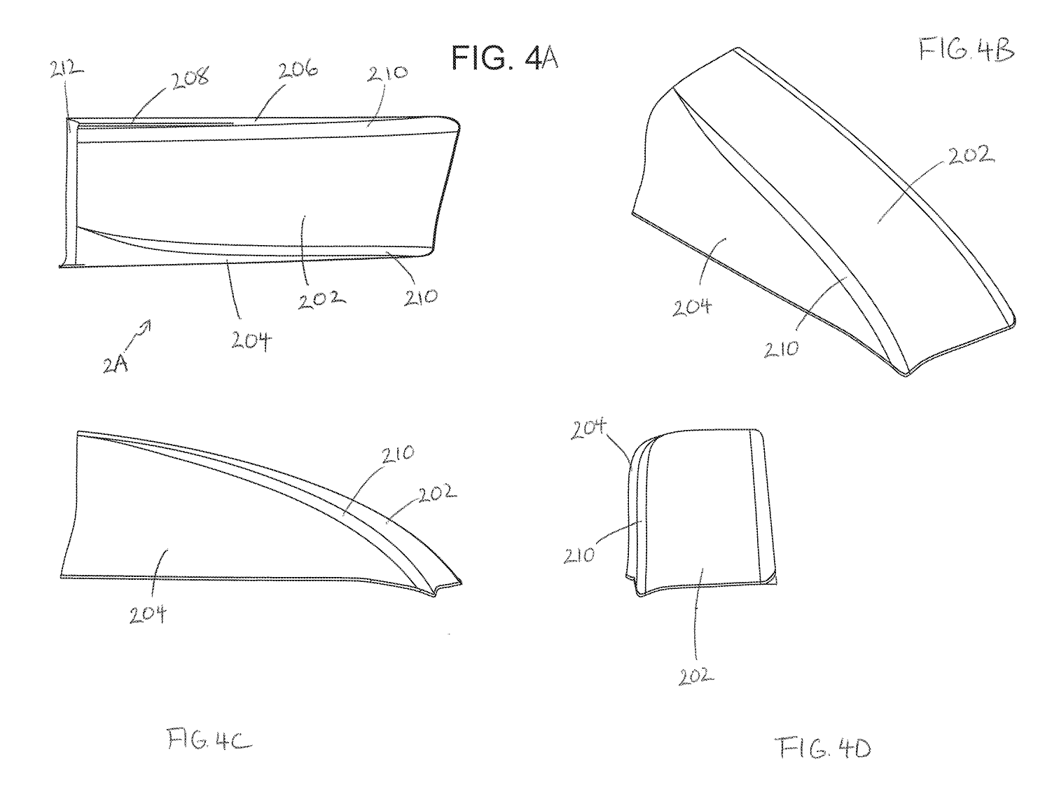

FIGS. 4A-4D illustrate an exemplary embodiment of the second fairing left part 2A. The second fairing may be shaped for various reasons. The second fairing, which can be oriented towards a rear end of the vehicle, can be designed for aesthetic reasons and/or aerodynamic reasons. The second fairing may shield the end of the awning system from visibility. In some embodiments, each of the sides of the vehicle can have a second fairing for each awning, such that the second fairing has a left part 2A and a right part 2B. In some embodiments, the second fairing may extend transversely across the vehicle and cover awnings on both sides of the vehicle. FIGS. 4A-4D illustrate an embodiment of the second fairing left part 2A having dimensions of 19.80 inches in length, 7.40 inches in width, and 7.67 in height with other dimensions contemplated. FIG. 4A illustrates a top plan view of the second fairing left part 2A. The second fairing left part 2A can have a generally rectangular shape from the top view, defined by a top surface 202. FIG. 4B illustrates a perspective view from a rearward side. The second fairing left part 2A can have a left side surface 204 having a generally right triangular shape, with the generally right angle at a forward bottom corner of the left side surface 204. The left side surface 204 can be adjacent to the top surface 202, with the top surface 202 tapering downward rearwardly following the hypotenuse of the triangular shape. The right side surface 206 can generally mirror the left side surface 204 in its triangular shape. The top surface 202 can join with the left side surface 204 and the right side surface 206 with fillets 210. At the raised forward portion of the second fairing left part 2A can be a forward surface 212. The forward surface 212 can have a concave curvature. The forward surface 212 and the right side surface 206 can have a channel 208 as further shown in FIG. 1. FIG. 4C illustrates a side plan view of the second fairing left part 2A. FIG. 4D illustrates a rear plan view of the second fairing left part 2A.

The second fairing can be made from a suitable material, such as at least one of a metal, a polymer, a composite. In embodiments, the first fairing 1 can be made from a combination of materials, including composite reinforced metals, to provide sufficient strength. The second fairing right part 2B can be understood as being reflectively symmetrical, or mirroring, the second fairing left part 2A.

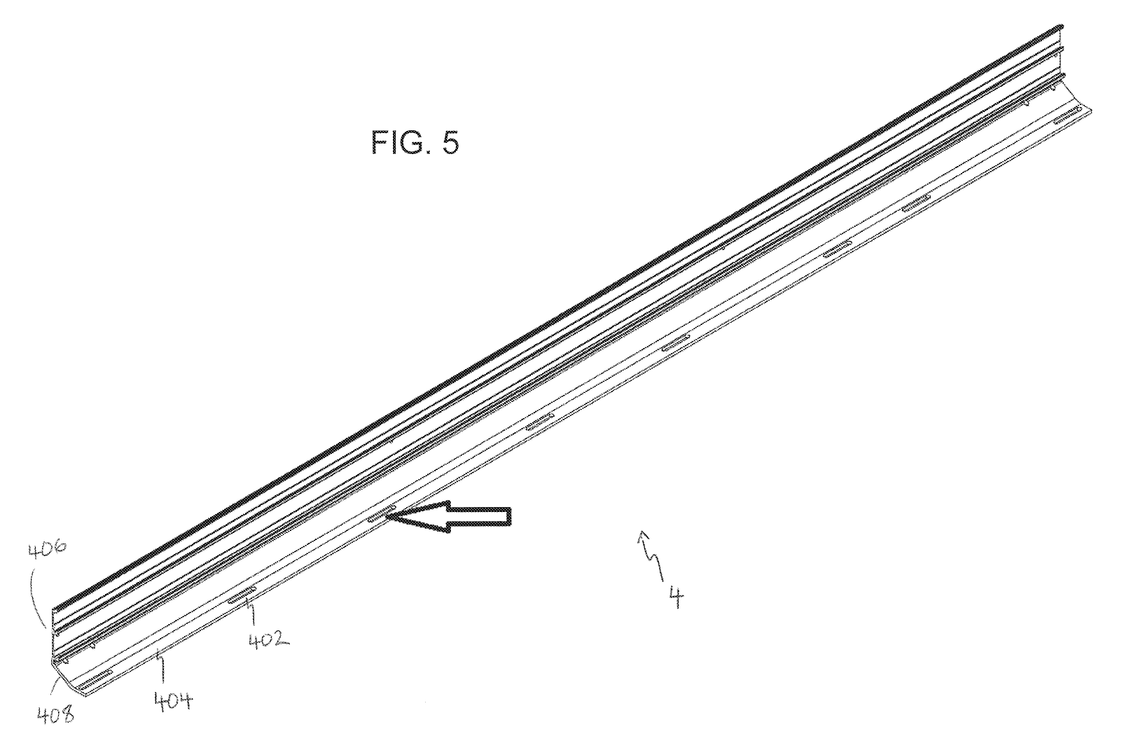

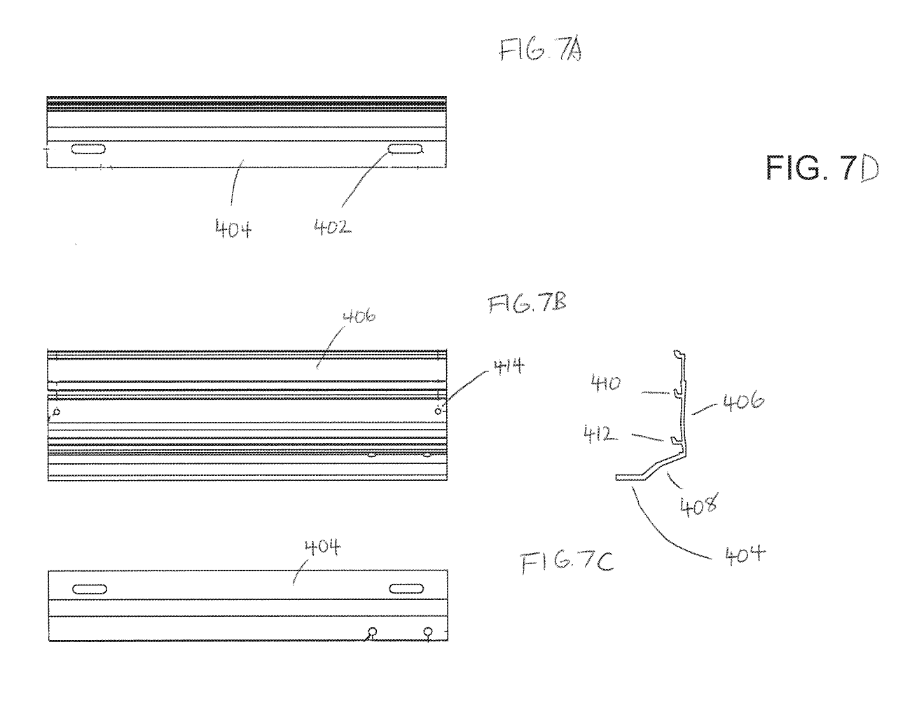

FIG. 5 illustrates a perspective view of an exemplary embodiment of an awning bracket 4. The exemplary awning bracket 4 can extend along the length of the awning 5 as necessary for support purposes. The exemplary awning bracket 4 can have a plurality of mounting points for attachment to the awning 5, bracket spacer 7, and frame structure 3. The cross sectional shape can be further shown in FIG. 7D. FIG. 5 illustrates an exemplary awning bracket with a plurality of mounting points 402 along a bottom wall 404 for mounting the awning bracket to the frame structure 3. A bracket spacer 7 can be used between the frame structure 3 and the awning bracket 4. The awning bracket 4 can have a side wall 406 generally perpendicular to the bottom wall 404. The side wall 406 and the bottom wall 404 can be joined by an angled wall 408, wherein the angled wall 408 is oblique to both the bottom wall 404 and the side wall 406.

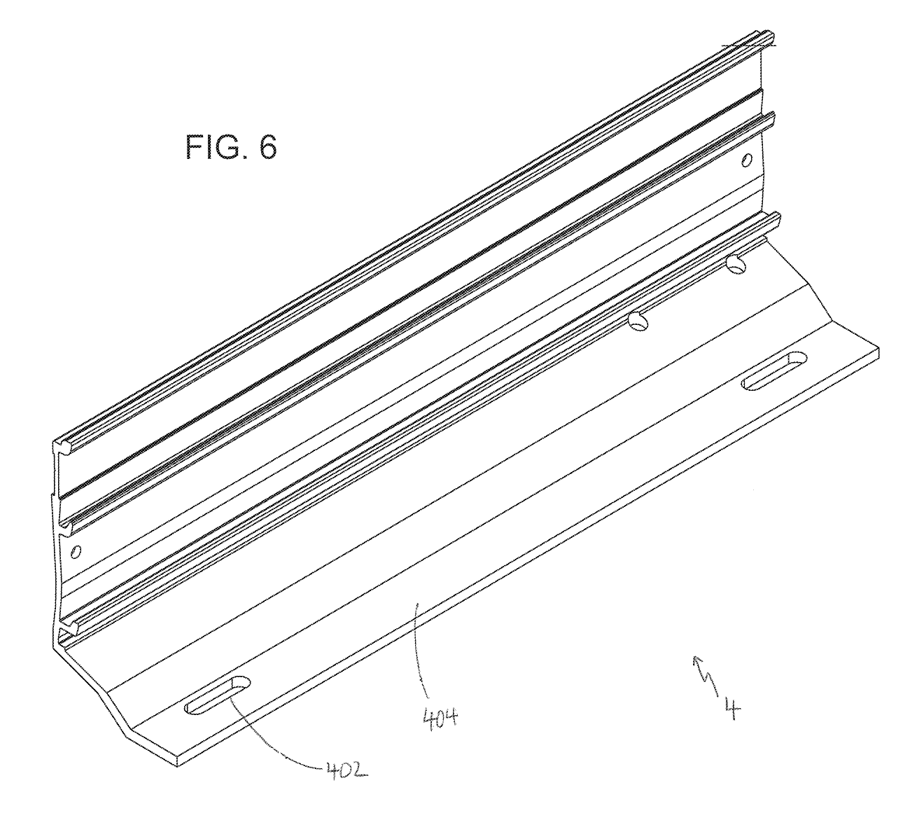

FIG. 6 illustrates a perspective view of an exemplary embodiment of an awning bracket 4. The awning bracket 4 of FIG. 6 can have the same cross sectional shape as the embodiment of FIGS. 5 and 7, with the awning bracket of FIG. 6 being shorter in length than the awning bracket of FIG. 5. The exemplary awning bracket 4 illustrates two lower slots to assist with mounting and can have an overall length of 19.75 inches in the exemplary embodiment.

FIGS. 7A-7D illustrate the dimensions of the exemplary embodiment of the awning bracket 4 as shown in FIG. 6. FIG. 7A illustrates a top plan view of the awning bracket 4. FIG. 7B illustrates a side plan view of the awning bracket 4. FIG. 7C illustrates a bottom plan view of the awning bracket 4. FIG. 7D illustrates a cross sectional shape of the awning bracket 4. The side wall 406 can have a set of rails, or projections, 410, 412 on a same side as the bottom wall 404. The set of rails 410, 412 can be used to engage the awnings 5. The awning bracket 4 can also have awning mounting holes 414 for fastening engagement of the awnings 5 to the awning bracket 4.

One or more embodiments of the present application can be generally built using the materials listed in the following Table 1. The exemplary materials are just one possible embodiment of the components as corresponds to the element numbers identified in FIG. 2 with other materials, shapes, and dimensions contemplated. The modular nature of the modular awning system would clearly allow for alternative sizing, in particular for the main bars, crossbar, and LED crossbar.

TABLE 1
Exemplary Bill of Materials

| | | | |
|---|---|---|---|
| Item | | Part | |
| No. | Item Desc. | No. | Quantity |

| | | |
|---|---|---|
| 1 | Front Fairing | 1 |
| 2A | 170″ Ext Rear Fairing Left | 1 |
| 2B | 170″ Ext Rear Fairing Right | 1 |
| 3A | T-Slot Extrusion, Main (180″ pc) | 2 |
| 3B | T-Slot Extrusion, Crossbar (180″ pc) | 0.5 |
| 4 | Awning Bracket | 8 |
| 5 | GG750 Awning 14′, Obravia w/LED, motor, | 2 |
| | rocker switch | |
| 5 | GG750 Awning 14′, Vinyl w/LED, motor, | 2 |
| | rocker switch | |
| 6 | LED Crossbar (45″ pc) | 1 |
| 7 | Front Bracket Spacer | 2 |
| 8 | T-Slot Corner Bracket, Off the Shelf | 20 |
| 8 | T-Slot Corner Bracket, Chapman | 20 |
| 8 | T-Slot Corner Bracket, ABC | 20 |

Embodiments of the components listed in Table 1 can be made from a suitable material, such as at least one of a metal, a polymer, a composite. In embodiments, the components can be made from a combination of materials, including composite reinforced metals, to provide sufficient strength. For example, the metal can include steel, aluminum, titanium, or an alloy. For example, the polymer can be a plastic of sufficient strength for vehicle applications. For example, the composite can include carbon fiber. Methods for making the components can include three dimensional printing.

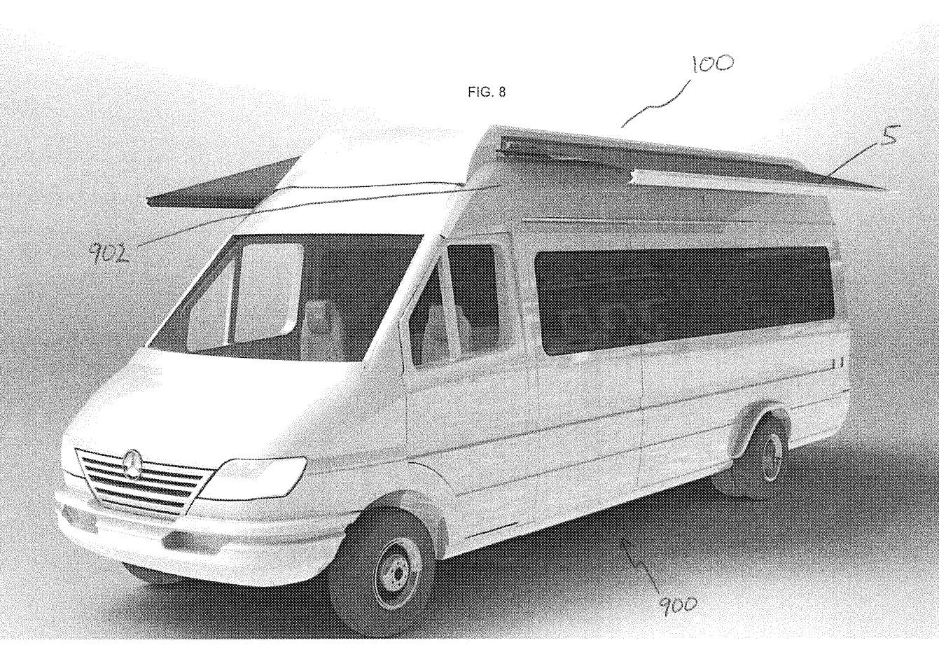

FIG. 8 illustrates an exemplary embodiment of a modular awning system 100 with awnings 5on both sides of the vehicle 900 in an extended, or deployed, position as seen from a front-side view of the van. As illustrated, sufficient clearance is provided between the awning 5 and the roof 902 of the vehicle 900 to allow for movement of the awning 5 without interference. Positioning of the frame structure 3 and awning brackets 4 for mounting the awning 5 can be set to allow for this clearance.

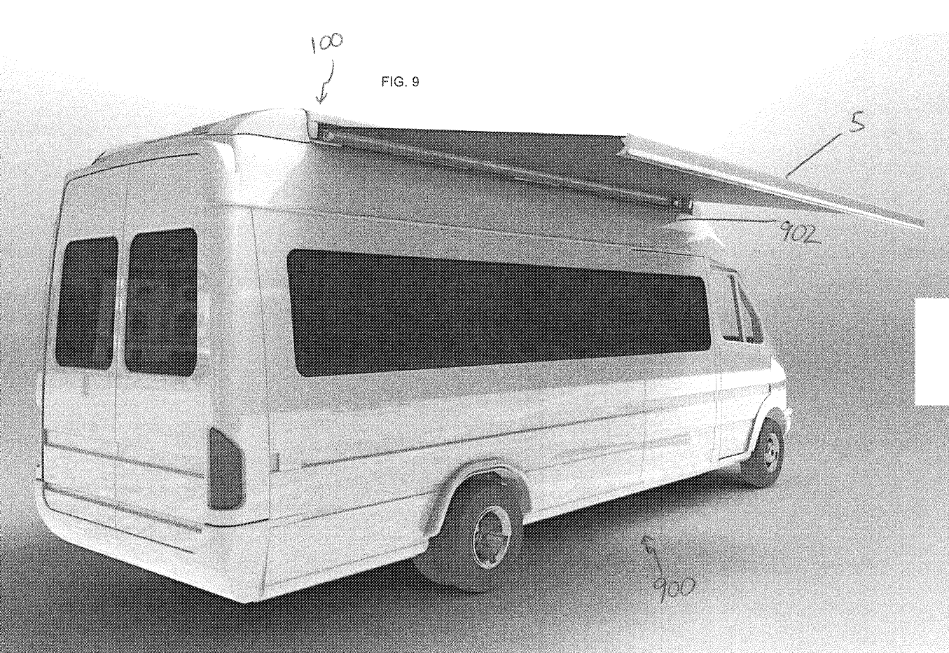

FIG. 9 illustrates an exemplary embodiment of a modular awning system 100 with an awning 5 in an extended, or deployed, position as seen from a rear-side view of the van.

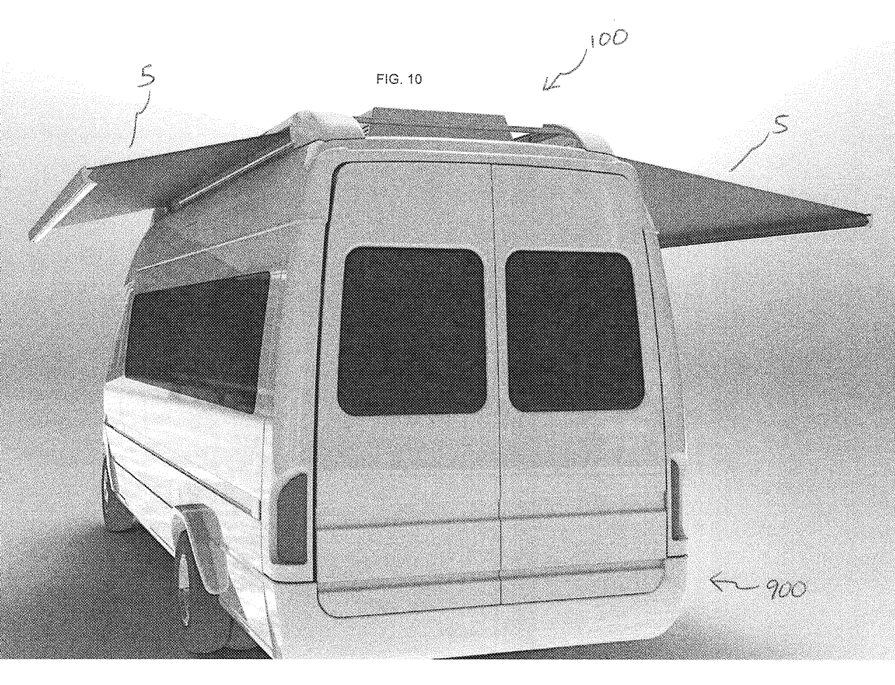

FIG. 10 illustrates an exemplary embodiment of a modular awning system 100 with awnings 5 on both sides of the vehicle 900 in an extended, or deployed, position as seen from a rear-side view of the van 900. In the exemplary embodiment, one awning 5 is extended farther from the side of the van than an awning 5 on the opposite side of the van. In some embodiments, the awnings 5 can be extended to any desired lengths from between a fully retracted, or stowed away, position to a fully extended, or deployed, position. In some embodiments, the awnings 5 can be sized differently, such that the fully deployed sizes of the awnings are different on each side of the vehicle 900.

In embodiments of different size awning 5, the frame and awning brackets 4 for the awnings may also be sized differently for the different weight requirements. This may be a consideration for weight savings for the vehicle. For example, a smaller awning 5 with less weight may use smaller awning brackets 4 or awning brackets 4 of a different material.

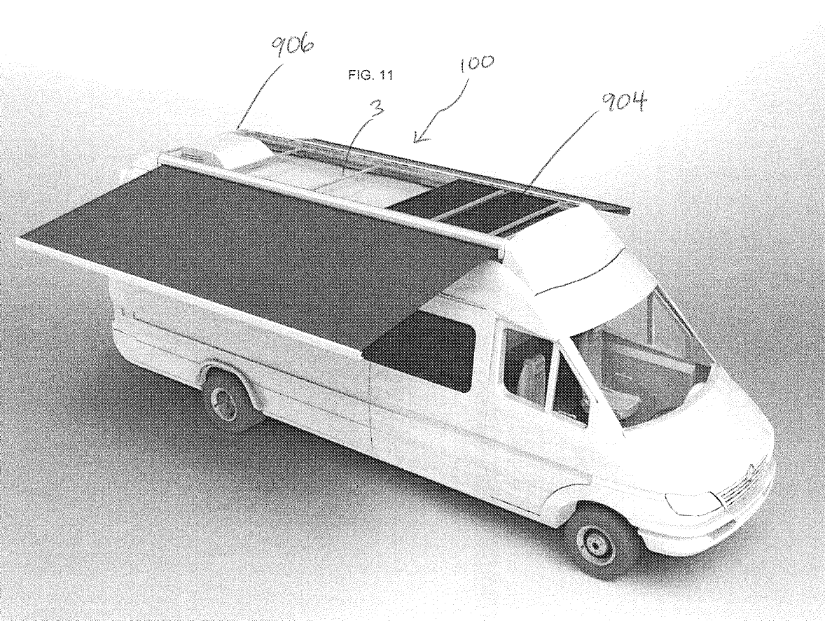

FIG. 11 illustrates an exemplary embodiment of a modular awning system 100 with awnings 5 on both sides of the vehicles in an extended, or deployed, position as seen from a top-side view of the van 900. Additional external devices are shown. Devices that can be externally mounted may include solar panels 904 and air conditioning units 906. In some embodiments, the devices can be mounted to the frame structure 3. For example, solar panels 904 and associated electronics including inverters and batteries can be directed mounted to the frame structure 3. In such a way, the entire modular awning system 100, including power, can be easily and simply mounted to and removable from the vehicle as a modular unit. The awnings 5 can be operated with a remote controller located inside the vehicle that communicates directly with the modular unit. This can simplify replacement of components without interference from the frame structure 3 for removal of the solar panels 904. In other examples, the modular unit can be wired are integrated to the vehicle's control system.

Other devices or modular pods can also be attached to the frame structure 3 of the modular awning system 100. Specific modules can be sized to fit between the crossbar 3B or provide structural rigidity to that modular awning system 100. In some embodiments, the devices may be mounted directly to the vehicle 900 and the frame structure 3 of the modular awning system 100 can be sized to accommodate the devices. For example, the placement of the crossbar 3B may be adjustable to accommodate device placement.

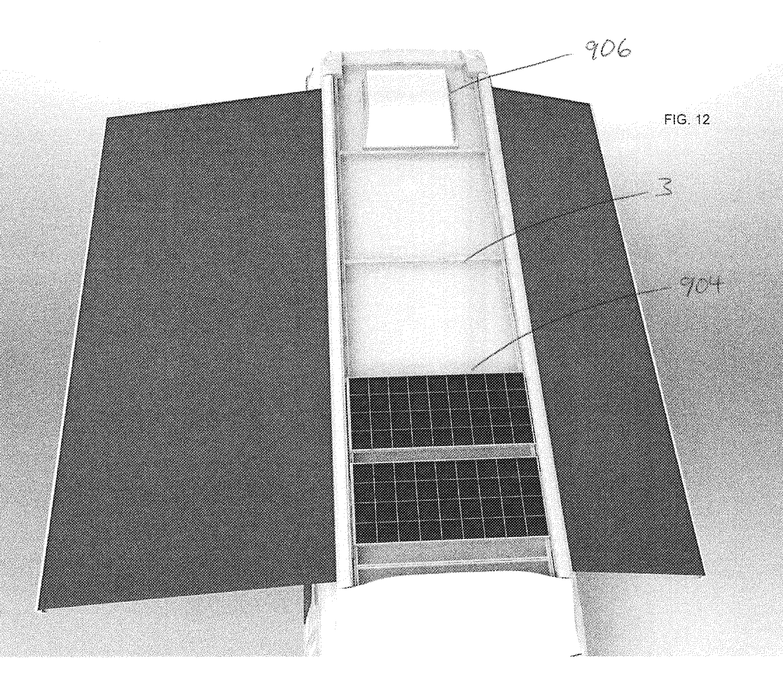

FIG. 12 illustrates an exemplary embodiment of a modular awning system 100 with awnings 5 on both sides of the vehicles 900 in an extended, or deployed, position as seen from an elevated perspective view of the van 900. The exemplary embodiment also illustrates placement of external devices on the vehicle with solar panels 904 and an air conditioning unit 906. Optionally, only one awning 5 can be activated. The awning 5 can also extend fully or partially extended.

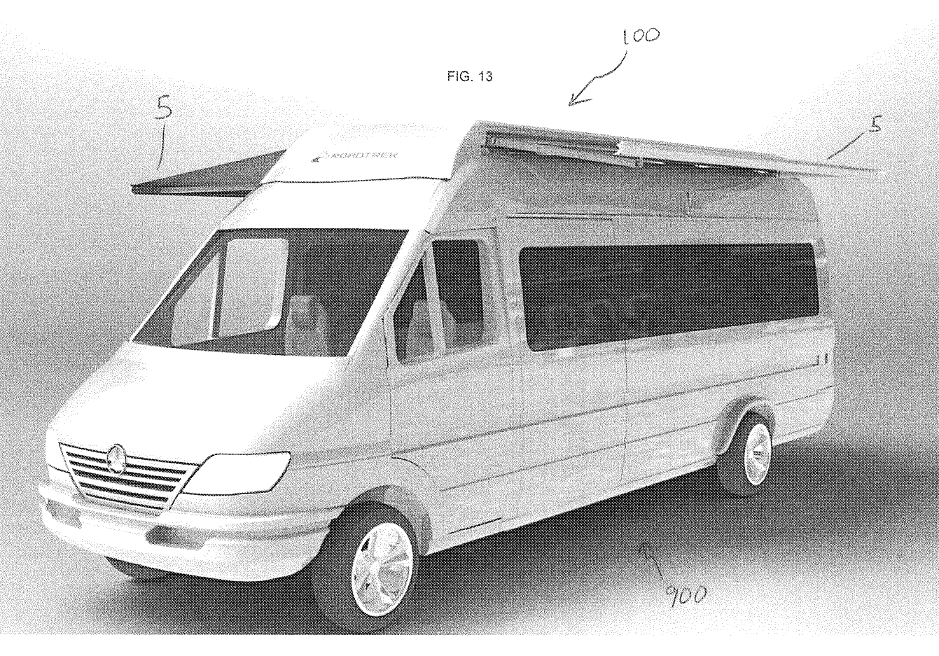

FIG. 13 illustrates an exemplary embodiment of a modular awning system 100 with awnings 5 on both sides of the vehicle 900 in an extended, or deployed, position as seen from a front-side view of the van.

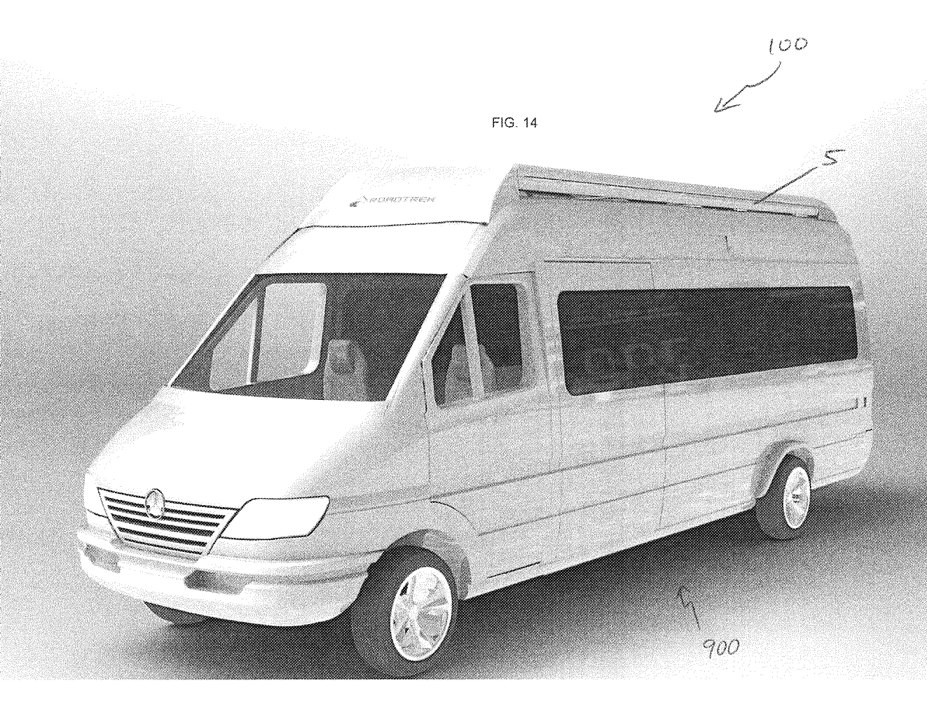

FIG. 14 illustrates an exemplary embodiment of a modular awning system 100 with awnings 5 on both sides of the vehicle 900 in a fully retracted position as seen from a front-side view of the van 900.

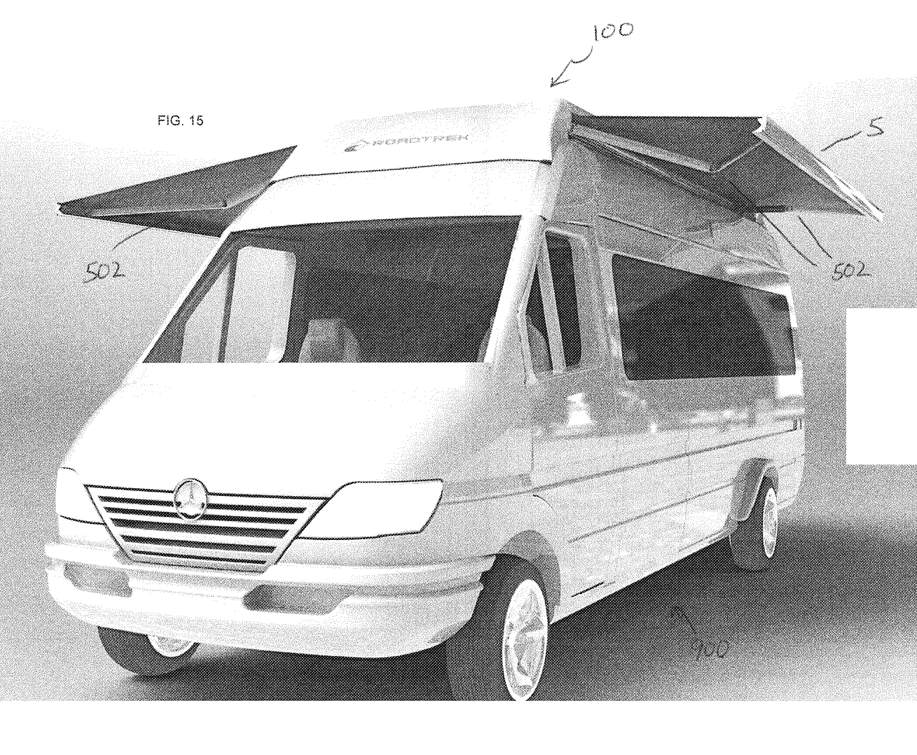

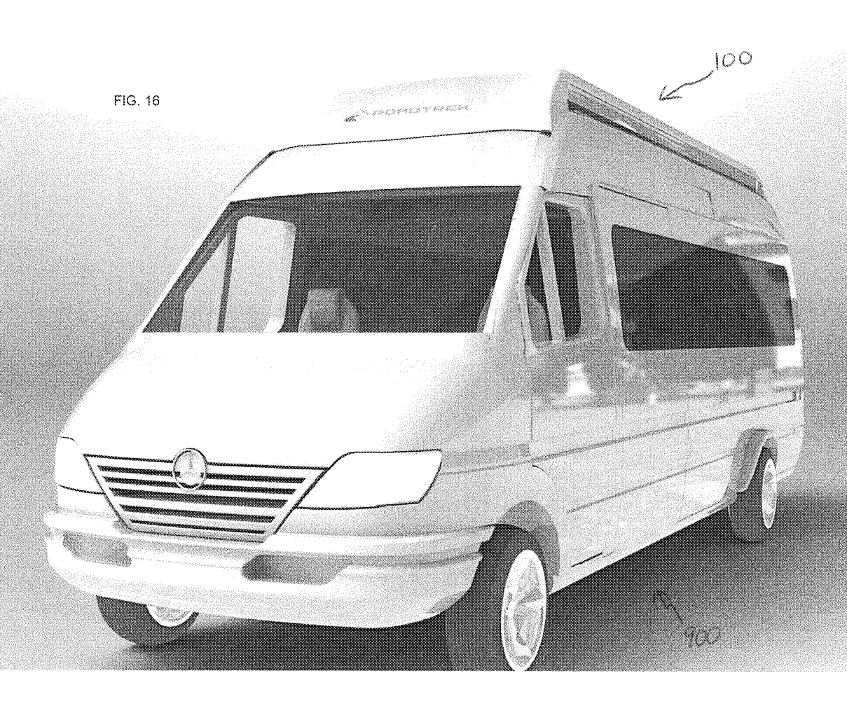

FIG. 15 illustrates an exemplary embodiment of a modular awning system 100 with awnings 5 on both sides of the vehicle 900 in an extended, or deployed, position as seen from a front-side view of the van 900. The awnings 5 can have awning arms 502 to provide structural rigidity to the awning 5 as it is extended. The awning arms 502 can also fully retract into the modular awning system 100 for a sleek appearance as shown in FIG. 16. The awning arms 502 can be of various configurations to provide structural rigidity.

FIG. 16 illustrates the embodiment of a modular awning system 100 of FIG. 15 with awnings 5 on both sides of the vehicle 900 in a fully retracted position as seen from a front-side view of the van 900.

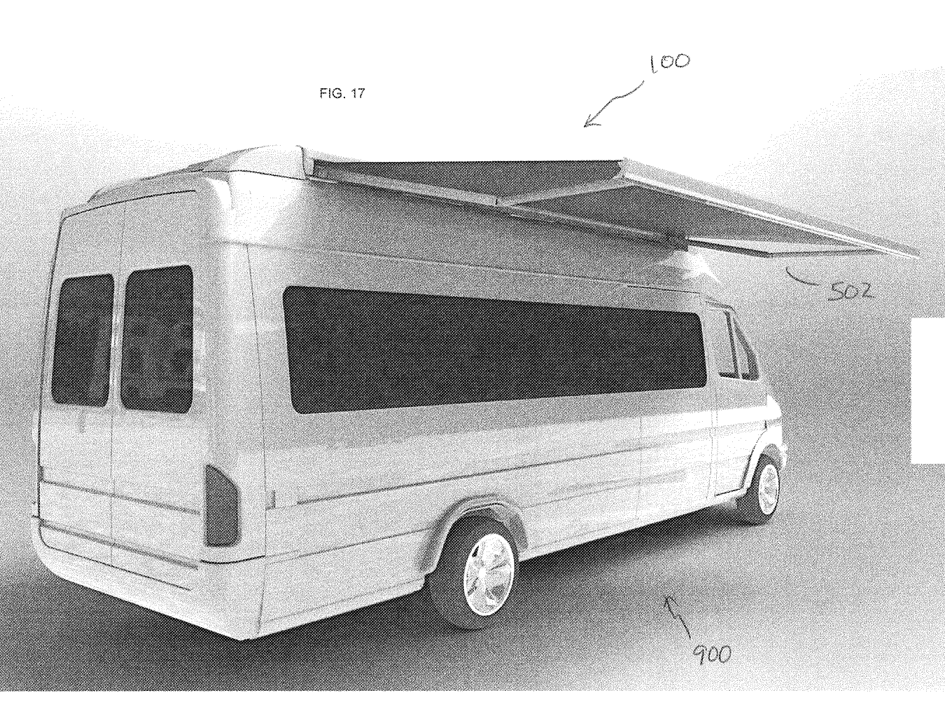

FIG. 17 illustrates an exemplary embodiment of a modular awning system 100 with an awning 5 in an extended, or deployed, position as seen from a rear-side view of the van 900.

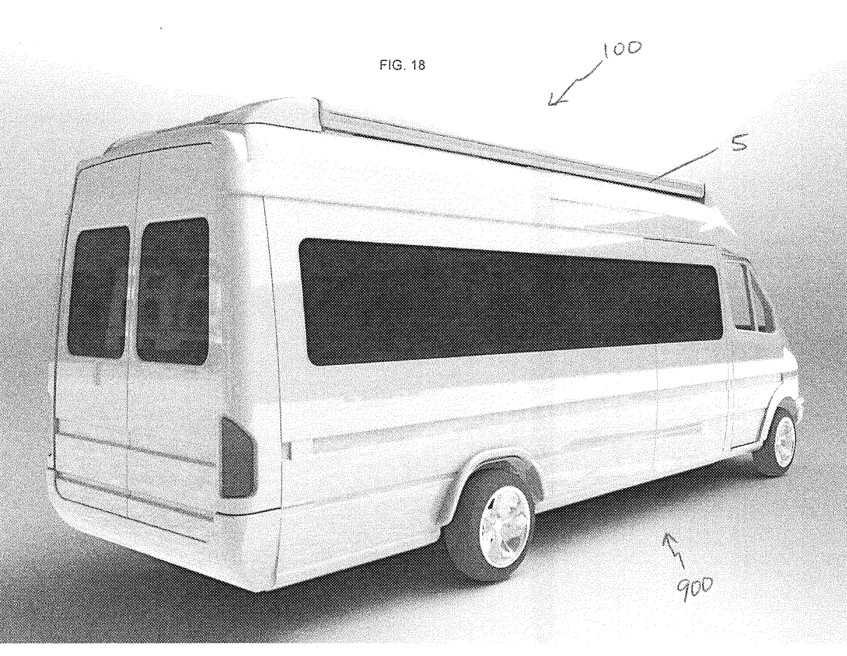

FIG. 18 illustrates an exemplary embodiment of a modular awning system 100 with an awning 5 in a fully retracted as seen from a rear-side view of the van 900.

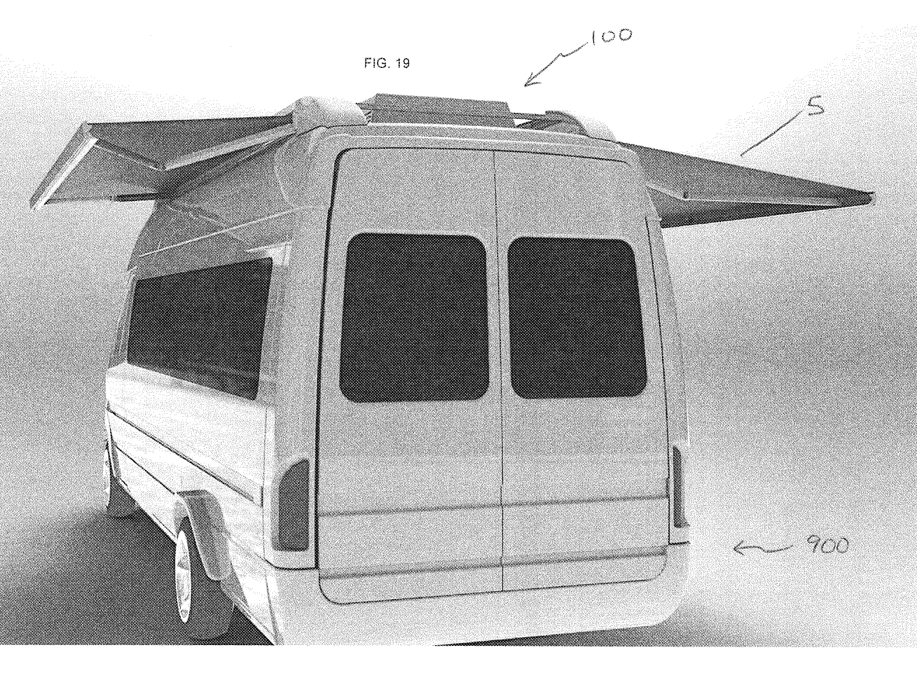

FIG. 19 illustrates an exemplary embodiment of a modular awning system 100 with awnings 5 on both sides of the vehicle 900 in an extended, or deployed, position as seen from a rear-side view of the van 900. In the exemplary embodiment, one awning 5 is extended farther from the side of the van 900 than an awning 5 on the opposite side of the van 900. In some embodiments, the awnings 5 can be extended to desired lengths from between fully retracted to fully extended. In some embodiments, the awnings 5 can be sized differently, such that the fully deployed sizes of the awnings 5 are different on each side of the vehicle 900. In embodiments of different size awning 5, the frame structure 3 and awning brackets 4 for the awnings 5 may also be sized differently for the different weight requirements. This may be a consideration for weight savings for the vehicle 900. For example, a smaller awning 5 with less weight may use smaller awning brackets 4 or awning brackets 4 of a different material.

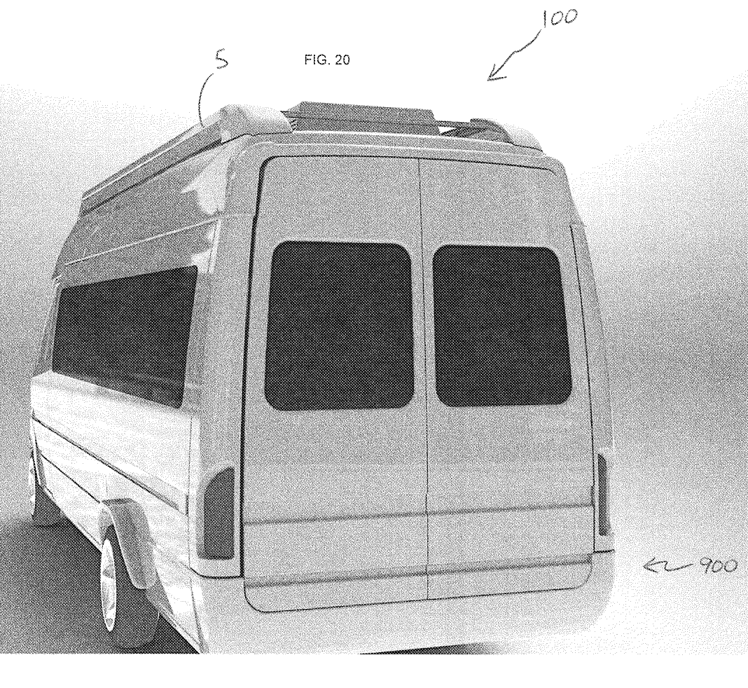

FIG. 20 illustrates an exemplary embodiment of a modular awning system 100 with awnings 5 on both sides of the vehicle 900 in a fully retracted position as seen from a rear view of the van 900.

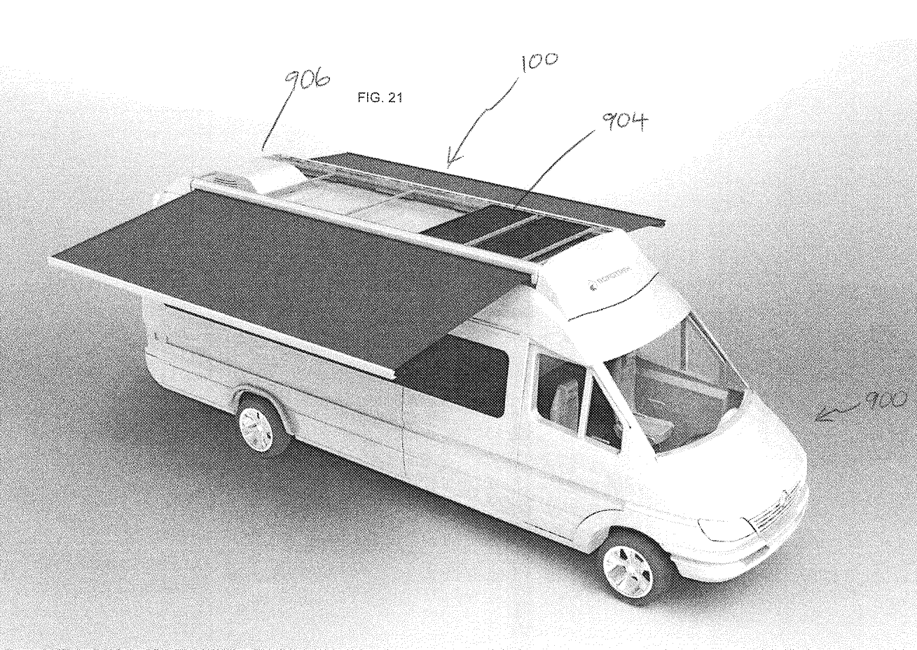

FIG. 21 illustrates an exemplary embodiment of a modular awning system 100 with awnings 5 on both sides of the vehicle 900 in an extended, or deployed, position as seen from a top-side view of the van 900.

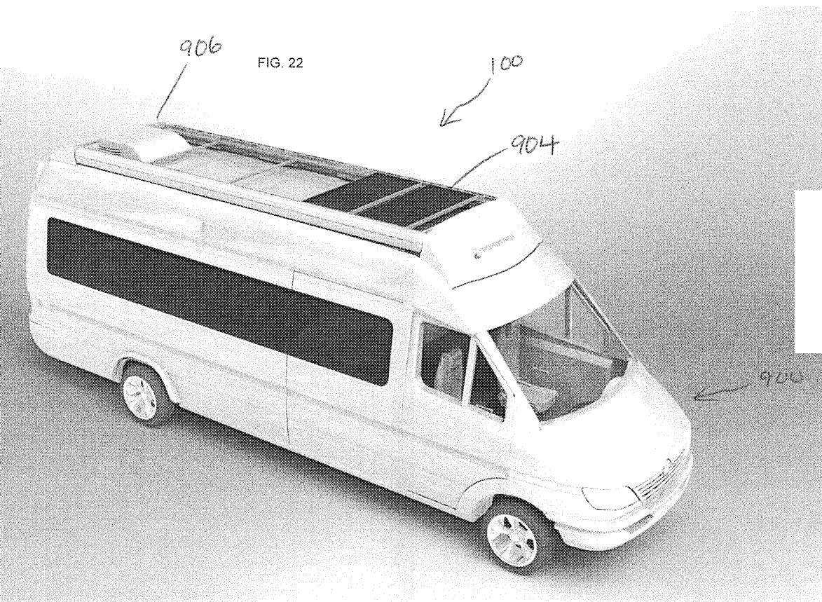

FIG. 22 illustrates an exemplary embodiment of a modular awning system 100 with awnings 5 on both sides of the vehicle 900 in a fully retracted position as seen from a top-side view of the van 900.

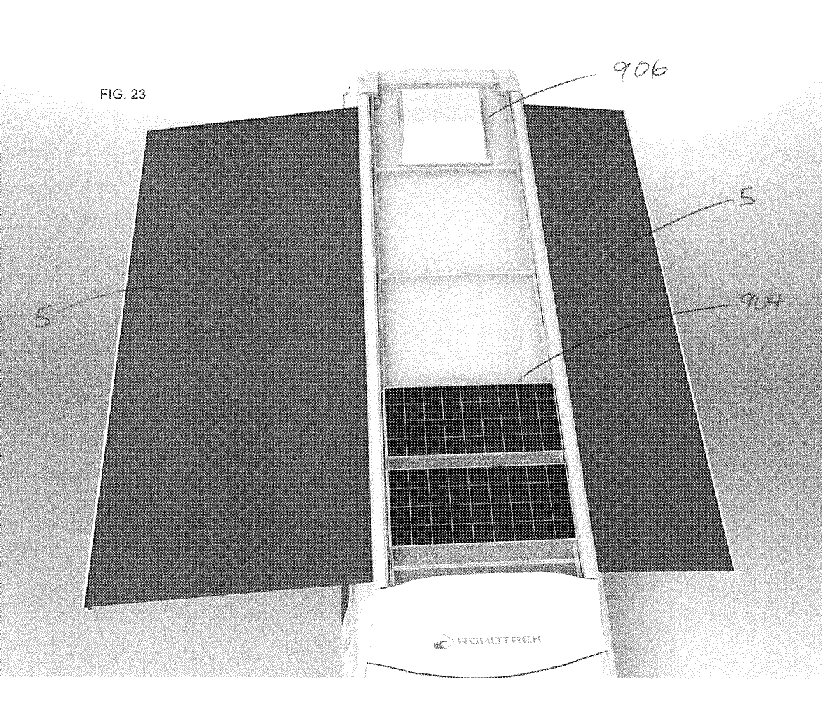

FIG. 23 illustrates an exemplary embodiment of a modular awning system 100 with awnings 5 on both sides of the vehicle 900 in an extended, or deployed, position as seen from an elevated perspective view of the van 900.

Methods of making and of using the modular awning systems and components thereof are within the scope of the present disclosure.

Although limited embodiments of modular awning systems, their components, and related methods have been specifically described and illustrated herein, many modifications and variations will be apparent to those skilled in the art. Accordingly, it is to be understood that the modular awning systems, their components, and related methods constructed according to principles of the disclosed devices, systems, and methods may be embodied other than as specifically described herein. Furthermore, it is understood and contemplated that features specifically discussed for one embodiment may be adopted for inclusion with another embodiment, provided the functions are compatible. Accordingly, it is to be understood that the assemblies, their components, and related methods constructed according to principles of the disclosed devices, systems, and methods may be embodied other than as specifically described herein. The disclosure is also defined in the following claims.

What is claimed:

1. A modular awning system for a vehicle comprising:
a first fairing comprising a surface, two ends, and a center section located between the two ends;
a second fairing spaced from the first fairing;
a frame disposed between the first fairing and the second fairing; and
an awning having cover fabric in a stowed-away state, said awning coupled to the frame;
wherein the frame is sizeable from a first size to a second size, which is smaller than the first size, for use on a recreational vehicle.

2. The module awning system for a vehicle of claim 1, wherein the awning is sizeable from a first size to a second size, which is smaller than the first size, for use on a recreational vehicle.

3. The modular awning system for a vehicle according to claim 1, further comprising:
a bracket spacer; and
an awning bracket secured to the awning.

4. The modular awning system for a vehicle according to claim 3,
wherein the awning is directly mounted to the awning bracket;
wherein the awning bracket is directly mounted to the bracket spacer; and
wherein the bracket spacer is directly mounted to the frame.

5. The modular awning system for a vehicle according to claim 1, wherein the awning is a first awning, and further comprising a second awning attached to the frame, spaced from the first awning.

6. The modular awning system for a vehicle according to claim 1, wherein the frame comprise a first elongated main, a second elongated main, and a crossbar connected to the first elongated main and the second elongated main.

7. The modular awning system for a vehicle according to claim 6, wherein the crossbar comprises a plurality of LEDs.

8. The modular awning system for a vehicle according to claim 7, wherein the crossbar is a first crossbar, and further comprising a second crossbar and a third crossbar.

9. A modular awning system for a vehicle comprising:
a first fairing configured to be mounted transversely at a front of a vehicle compared to a second fairing; said second fairing comprising a second fairing left part and a second fairing right part;
a frame connected to the first fairing and the second fairing, said frame comprising a first elongated main, a second elongated main, and at least one crossbar connected to the first elongated main and the second elongated main;
a first awning and a second awning, the first awning and the second awning coupled to the frame;
wherein each of the first awning, the second awning, and the frame is sizeable from a first size to a second size, which is smaller than the first size, to scale the modular awning system to a vehicle;
wherein the front fairing comprises a surface to cover respective first ends of the first awning and the second awning; and
wherein the second fairing comprises a surface to cover respective second ends of the first awning and the second awning.

10. A method for mounting a modular awning system to a vehicle comprising:
shortening a frame from a first frame length to a second frame length to set the frame to the second frame length; the frame comprising a first end and a second end;
shortening an awning from a first awning length to a second awning length to set the awning to the second awning length;
attaching the awning to the frame and the frame to a roof of a vehicle; and
placing a first fairing having a surface at the first end of the frame and a second fairing having a surface at the second end of the frame.

11. The method of claim 10, further comprising shortening a crossbar from a first crossbar length to a second crossbar length and attaching the crossbar to a first elongated main and a second elongated main.

12. The method of claim 11, wherein the crossbar is a first crossbar, further comprising shortening a second crossbar and attaching the shortened second crossbar to first elongated main and the second elongated main.

13. The method of claim 11, wherein the awning is a first awning, and further comprising shortening a second awning and attaching the second awning to the frame.

14. The method of claim 10, further comprising wiring the frame to a power source to power LED lights mounted to the frame.

15. The method of claim 10, further comprising using a remote control to extend a cover fabric from the awning.
